(19) United States
(12) Patent Application Publication
(10) Pub. No.: US 2017/0079303 A1
(43) Pub. Date: Mar. 23, 2017

(54) METHOD FOR OBTAINING SOLID FAT WITH LOW SATURATED FATTY ACID CONTENT

(71) Applicant: ACEITES DEL SUR-COOSUR, S.A., Vilches (ES)

(72) Inventors: Pablo GÓMEZ RODRÍGUEZ, Vilches (ES); Andrés GARCÍA SÁNCHEZ, Vilches (ES); Jesús JIMÉNEZ LÓPEZ, Vilches (ES)

(21) Appl. No.: 15/266,953

(22) Filed: Sep. 15, 2016

(30) Foreign Application Priority Data
Sep. 18, 2015 (ES) 201531336

(51) Int. Cl. A23D 7/00

(52) U.S. Cl. CPC A23D 7/003

(57) ABSTRACT

The present disclosure relates to a method for producing healthy fats characterized by being solid at room temperature and by having a high percentage of monounsaturated fatty acids/polyunsaturated fatty acids (MUFAs/PUFAs) and a low percentage of saturated fatty acids (SFAs). Furthermore, trans fatty acids are not generated while implementing the method.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims priority from and the benefit of Spanish Patent Application No. ES 201531336, filed on Sep. 18, 2015, which is hereby incorporated herein by reference in its entirety.

### BACKGROUND

Field

The present disclosure can be categorized to be within the food and human health sector. More specifically, the present disclosure relates to a method for producing or obtaining healthy fats characterized by being solid at room temperature and by having a high percentage of monounsaturated fatty acids/polyunsaturated fatty acids (MUFAs/PUFAs) and a low percentage of saturated fatty acids (SFAs). Furthermore, trans fatty acids are not generated while implementing the method of the disclosure.

Description of the Related Technology

Saturated fats (characterized by not having double bonds) are fundamentally found in foods that come from animals, such as meats, sausages, milk and milk products (cheese, ice-cream, etc.). They can also be found in vegetable oils, such as coconut or palm oils (which are consumed through mass-produced baked goods, salty snack foods and processed products). These are fats that solidify at room temperature. The consumption of saturated fats favors an increase in blood cholesterol levels, with LDL cholesterol (bad cholesterol) being one of the main risk factors for heart diseases.

Unsaturated fats (characterized by having double bonds) are mostly found in foods that come from plants, such as vegetable oils (olive, sunflower or corn oil). They can also be found in dried nuts and fruits and in seeds such as sesame seeds, sunflower seeds or linseeds. Although coconut or palm oils are vegetable oils, they contain SFAs, instead of UFAs, as the main fatty acids. These are fats that are liquid at room temperature. According to the number of double bonds they have, they are classified as monounsaturated or polyunsaturated. Substituting saturated fats with unsaturated fats in the diet helps to maintain normal blood cholesterol levels which are essential for regulating metabolic processes of the cardiovascular, immune and pulmonary systems, among others.

Trans fatty acids (TFAs) are a type of unsaturated fatty acid that are mainly found in processed foods. Trans fatty acids are conventionally formed in the hydrogenation process performed on fats for the purpose of solidifying them for later use in different foods. An example of this is the solidification of liquid vegetable oil to manufacture margarine. In fact, if a fat is liquid at room temperature, it is mostly made up of UFAs generally in cis form [Ghotra, B. S., Dyal, S. D., Narine, S. S. (2002). “Lipid shortenings: a review”, Food Research International 35, 1015-1048].

Not only do trans fatty acids increase the concentration of low density lipoproteins (LDLs) in the blood, but they also reduce high density lipoproteins (HDLs, which are referred to in layman's terms as “good cholesterol”), giving rise to a higher risk of suffering cardiovascular diseases [Cindio B., Lupi F. R., (2011), Part 2, Chap. 15—“Saturated fat reduction in pastry” in Talbot G., “Reducing saturated fats in foods”, Woodhead Publishing Limited (Great Abington, Cambridge, UK), pp. 301-317].

Accordingly, the search for alternative techniques for preparing solid fats at room temperature with a low SFA content and a method for obtaining such fats that does not generate trans fatty acids is a prime objective.

Among the alternative processes proposed in the prior art to avoid producing trans isomers is the interesterification of vegetable oils and saturated fats [Criado, M., Hernández-Martín, E., López-Herández, A., Otero, C., (2007). “Enzymatic interesterification of extra virgin olive oil with a fully hydrogenated fat: characterization of the reaction and its products”. Journal of American Oil Chemists Society 8, 717-26]. Interesterification is the process of rearranging (randomly or in a directed manner) the acyl groups in one and the same triacylglycerol or between molecules of different triacylglycerols. The process can be carried out chemically or enzymatically, according to whether chemical catalysts (metallic sodium, sodium alkoxides) or enzymes (lipases) are used. Even though it was initially thought that interesterified fats or oils would be a healthy alternative to using trans fats in the food industry, it has been shown that they are similarly harmful, since they increase glucose levels (blood sugar) and reduce the presence of good cholesterol or HDL. Furthermore, they have not been proven and approved by the FDA.

Another alternative to producing trans fatty acids is to add saturated fats in the oil in liquid phase with an emulsifier and a stabilizer for the purpose of increasing the hardness of the end fat [Jahaniaval, F., (2005). “Process for preparing high liquid oil, no trans, very low saturates, regular margarine with phospholipids”, US patent application 2005/0233056 A1, with international classification A23D007/00]. However, the use of water in the manufacturing processes can involve some technical issues.

Furthermore, research has been conducted in recent years on a new line of sunflower called high stearic/high oleic sunflower oil, or water/oil emulsions have been developed from vegetable proteins or mono- and diglycerides as binders, among others. However, in the case of high stearic/high oleic oil, it can be seen that they are not able to achieve a really low level of SFAs and a high melting point of the end fat. In turn, water/oil emulsions have the drawback of not being pure fat, but rather a certain amount of water is introduced, with the technological issues that this may involve in some manufacturing processes.

Therefore, after studying the prior art, a clear need for finding a process for producing or obtaining solid fats at room temperature with a high content of any oil (preferably vegetable oil) with a high percentage of MUFAs/PUFAs and a low percentage of SFAs has been identified. Furthermore, it is important that trans fatty acids are not generated while implementing the process for producing the fat.

### SUMMARY

As will be explained below, the disclosure describes a solution to said technical problem by means of applying a process known as crystallization, using as a crystallizing agent a composition that is precisely defined below.

Disclosed herein is a method for obtaining solid fat at room temperature having a high percentage of MUFAs/PUFAs and a low percentage of SFAs. Furthermore, the method of the disclosure is characterized by not generating trans fatty acids. The method generally comprises crystallizing the triglycerides of the oils to be solidified by means of using a crystallizing agent comprising a mixture of completely hydrogenated vegetable triglycerides. When the triglycerides of the crystallizing agent transition from a liquid to solid state, they act like crystallization initiating nuclei, and the triglycerides of the oils to be solidified located in the surrounding areas accordingly start to gather around same. This causes the oil to solidify without any chemical modification thereof (as occurs with hydrogenation for example), i.e., without generating trans fats, achieving a final solid fat at room temperature with a high MUFA or PUFA content, and a low SFA content that is characteristic of most vegetable oils.

In the present disclosure, room temperature is understood as those temperatures lower than body temperature (37° C.).

Furthermore, in the present disclosure it is understood that there is a low SFA content when the percentage of SFAs in the final mixture is equal to or less than 35%.

The composition of the fat obtained is generally shown in Table 1.

TABLE 1

| | Composition |
|---|---|
| | (w/w %) |
| Vegetable and/or animal oil | 69-92 |
| Crystallizing agent | 8-25 |
| Mono- and diglycerides | 0-6 |

Accordingly, one embodiment relates to the crystallizing agent to be used to produce fat characterized by being solid at room temperature and comprising a low percentage of SFAs, characterized in that it comprises, in decreasing order, stearic acid, palmitic acid, behenic acid and arachidic acid. In another embodiment, the crystallizing agent comprises the following percentages of fatty acids in decreasing order: 45-50% stearic acid, 25-30% palmitic acid, 14-19% behenic acid and 2-4% arachidic acid. In another embodiment, the crystallizing agent is characterized in that it comprises the following percentages of fatty acids in decreasing order: stearic acid 47.93%, palmitic acid 29.66%, behenic acid 17.40% and arachidic acid 3.85%. In another embodiment, the crystallizing agent is characterized by having the following as the main triglycerides: 50.7% PSS, 32.8% SSS, 8.22% BSS and 4.7% PPP. In another embodiment, the crystallizing agent is characterized by having the following, in decreasing order, as the main triglycerides: PSS, SSS, BSS and PPP (P=palmitic, S=stearic, B=behenic). The crystallizing agent is the key element of the disclosure as it is required for achieving crystallization and, hence, solidification of the oil added at room temperature. The higher the amount of crystallizing agent, the harder the end fat and the higher the melting point will be.

The expression “decreasing order” referring to the fatty acid composition giving rise to the crystallizing agent means that said crystallizing agent can be made up of different percentages of the SFAs mentioned in the preceding paragraph, on the condition that the percentage of stearic acid in the composition is greater than the percentage of palmitic acid, the percentage of palmitic acid is greater than the percentage of behenic acid, and the percentage of behenic acid is greater than the percentage of arachidic acid.

Another embodiment relates to a method for obtaining solid fat at room temperature with a low percentage of SFAs, characterized in that it comprises: a) heating a mixture comprising the crystallizing agent defined above with the oil to be solidified to 65-80° C., b) cooling the mixture to 30-45° C. with simultaneous vigorous stirring and c) packaging and letting stand at 0-4° C. or at room temperature for at least 24 hours. In another embodiment, the method is characterized by not generating trans fatty acids. In another embodiment, the method is characterized in that the mixture of step a) further comprises 0-6% of fatty acid mono- and diglycerides.

In another embodiment, the method is characterized in that the oil to be solidified is a vegetable oil, animal oil or a mixture of vegetable oil and animal oil. In another embodiment, the method is characterized in that the mixture of step a) comprises about 69-92% of the oil to be solidified and about 8-25% of crystallizing agent.

In another embodiment, the method is characterized in that the solid fat obtained comprises about 65-85% of UFAs and about 15-35% of SFAs.

Therefore, the resulting product is a vegetable fat, animal fat or a mixture of both (depending on the origin of the oil to be solidified) with melting points above 37° C. and the physicochemical composition characteristics of which will depend on the percentages of the crystallizing agent and on the oil to be crystallized used in the mixture of step a) described above, as well as the nature of the oil. In another embodiment, the oil to be solidified is a vegetable oil, for example: olive oil, sunflower oil, corn oil, soybean oil, palm oil, grapeseed oil, hemp oil, nut oil, etc. Nevertheless, this process is also valid for being used with other oils and fats that do not come from plants, such as fish oil or pig lard. The characteristics of the crystals formed are affected both by the types of oil used and by work conditions. A quicker mixture cooling process favors generating a larger amount of crystals but they are smaller in size due to the shorter time the triglycerides have to gather into crystals, as well as to more vigorous stirring. In contrast, longer cooling processes and gentler stirring generate a lower number of crystals but they are larger in size, so unwanted fats having a grainy consistency are generated. Finally, it is important to note that the method does not comprise any step in which the fat finally obtained is emulsified nor is there any presence of water.

Given that it is possible to obtain fats with sufficient consistency and hardness with concentrations starting from 8% of crystallizing agent, the method allows almost the only component to be the oil to be solidified. The result, especially when using healthy oils such as olive oil, sunflower oil, soybean oil or the like is that the lipid profile, and therefore the nutritional characteristics, will be very similar to those of the starting oil or oils used.

Another embodiment relates to a solid fat at room temperature with a low percentage of SFAs. In another embodiment, said fat is obtained through the method described above. In another embodiment, the obtained fat is characterized in that it comprises about 69-92% of the solidified oil and about 8-25% of the crystallizing agent defined above. The entire mixture resulting from the oil to be solidified with the crystallizing agent after the preparation process shows a lipid profile that coincides with percentage of components used. In another embodiment, the fat is characterized in that the solidified oil comprises about 65-85% of UFAs and about 15-35% of SFAs.

In another embodiment, the solid fat at room temperature with a low percentage of SFAs is characterized in that the solidified oil is a vegetable oil, animal oil or a mixture of vegetable oil and animal oil. In fact, any oil or fat from an animal or plant, as well as the mixture of both, can be used in the solidification process for obtaining a solid fat. This makes the process obviously versatile since it allows obtaining fats with different nutritional and technological characteristics depending on the type and the origin of the oil used.

Another embodiment relates to the use of the crystallizing agent defined above for producing the fat specified above.

### DETAILED DESCRIPTION

The purpose of the examples provided below is to illustrate certain embodiments of the disclosure and they must not be considered as limiting the scope thereof. Therefore, the examples described below must be taken into account as mere proof of concept that teach particular ways of carrying out the claimed disclosure.

### Example 1

### Different Formulations Obtained with the Method

The formulations with a higher percentage of crystallizing agent have higher melting points. The formulations with higher percentages of mono- and diglycerides are harder and have higher solid content at a low temperature.

| | Example A | Example B | Example C | Example D |
|---|---|---|---|---|
| | (w/w %) | (w/w%) | (w/w %) | (w/w %) |
| Vegetable and/or | 88.5 | 89 | 80 | 77 |
| animal oil | | | | |
| Crystallizing agent | 11.5 | 10 | 20 | 18 |
| Mono- and diglycerides | | 1 | | 5 |

### Example 2

### Composition Acting as the Crystallizing Agent

The composition acting as the crystallizing agent was obtained by means of mixing completely hydrogenated triglycerides from palm and rape seed. The crystallizing agent is characterized by being made up entirely of SFAs, including among such SFAs stearic acid, palmitic acid, behenic acid and arachidic acid.

The crystallizing agent used in this example has a melting point of 59° C. and is characterized in that it comprises the following percentages of fatty acids: 47.93% stearic acid, 29.66% palmitic acid, 17.40% behenic acid and 3.85% arachidic acid.

### Example 3

### Physicochemical Characterization of the Fat Obtained by the Method

In this example, a fat with the following percentages of crystallizing agent and refined olive oil was produced: 11.5% crystallizing agent and 88.5% refined olive oil to be solidified, obtaining the mixture shown below with a reduced percentage of SFAs.

| | Mixture A | Mixture B | Mixture C |
|---|---|---|---|
| | with | with | with |
| | olive oil | sunflower oil | sunflower oil |
| Melting point (° C.) | 42.9 | 40.8 | 54 |
| Fatty acid profile (%) | | | |
| Myristic acid (C14:0) | 0.05-0.08 | 0.08-0.12 | 0.08-0.13 |
| Palmitic acid (C16:0) | 12-16.5 | 8-12 | 11-15 |
| Palmitoleic acid | 0.8-1.2 | 0.08-0.11 | 0.06-0.09 |
| (C16:1) | | | |
| Stearic acid (C18:0) | 6-10 | 7-9 | 14.5-18 |
| Oleic acid (C18:1) | 50-70 | 20-25 | 18-23 |
| Linoleic acid (C18:2) | 5-8 | 52-59 | 47-52 |
| Linolenic acid (C18:3) | 0-0.8 | 0-0.4 | 0-0.3 |
| Arachidic acid (C20:0) | 0.6-0.8 | 0.5-0.8 | 0.7-1.1 |
| Behenic acid (C22:0) | 1-3 | 1.8-2.4 | 3-4.2 |
| Total SFA | 21-27.5 | 17.5-22 | 28.5-35 |
| Total MUFA | 51.3-68 | 20-25.5 | 18-23.5 |
| Total PUFA | 6-10 | 52-60 | 47-53 |

What is claimed is:

1. A crystallizing agent used to produce fat that is solid at room temperature and comprising a low percentage of saturated fatty acids, comprising in decreasing order: stearic acid, palmitic acid, behenic acid and arachidic acid.

2. The crystallizing agent according to claim 1, comprising the following percentages of fatty acids: 45-50% stearic acid, 25-30% palmitic acid, 14-19% behenic acid and 2-4% arachidic acid.

3. The crystallizing agent according to claim 2, wherein the fatty acid composition is obtained from a mixture of hydrogenated triglycerides from palm and rape seed.

4. A method for obtaining solid fat at room temperature with a low percentage of saturated fatty acids, comprising:
a. heating a mixture comprising the crystallizing agent of claim 1 with the oil to be solidified to 65-80° C.;
b. cooling the mixture to 30-45° C. with simultaneous vigorous stirring;
c. packaging and letting stand at 0-4° C. or at room temperature for at least 24 hours.

5. The method according to claim 4, wherein trans fatty acids are not generated.

6. The method according to claim 4, wherein the oil to be solidified is a vegetable oil, animal oil or a mixture of vegetable oil and animal oil.

7. The method according to claim 4, wherein the mixture comprises about 69-92% of the oil to be solidified.

8. The method according to claim 4, wherein the mixture comprises about 8-25% of crystallizing agent.

9. The method according to claim 4, wherein the mixture of step a) further comprises 0-6% of fatty acid mono- and diglycerides.

10. The method according to claim 4, wherein the solid fat obtained comprises about 65-85% of unsaturated fatty acids and about 15-35% of saturated fatty acids.

11. A solid fat at room temperature with a low percentage of saturated fatty acids obtained according to the method of claim 4.

12. The solid fat at room temperature with a low percentage of saturated fatty acids according to claim 11, comprising about 69-92% of the solidified oil and about 8-25% of the crystallizing agent.

13. The solid fat at room temperature with a low percentage of saturated fatty acids according to claim 11, where the solidified oil comprises about 65-85% of unsaturated fatty acids and about 15-35% of saturated fatty acids.

14. The solid fat at room temperature with a low percentage of saturated fatty acids according to claim 11, where the solidified oil is a vegetable oil, animal oil or a mixture of vegetable oil and animal oil.
